(19) United States
(12) Patent Application Publication
(10) Pub. No.: US 2014/0342029 A1
(43) Pub. Date: Nov. 20, 2014

(54) ROLLER DIE AND A METHOD FOR MANUFACTURING THE ROLLER DIE

(71) Applicant: HON HAI PRECISION INDUSTRY CO., LTD., New Taipei (TW)

(72) Inventor: CHIA-LING HSU, Tu-Cheng (TW)

(73) Assignee: HON HAI PRECISION INDUSTRY CO., LTD., New Taipei (TW)

(21) Appl. No.: 14/279,334

(22) Filed: May 16, 2014

(30) Foreign Application Priority Data
May 20, 2013 (TW) 102117701

(51) Int. Cl. B29D 11/00

(52) U.S. Cl. CPC B29D 11/00788
USPC 425/385; 427/577

(57) ABSTRACT

Manufacture of a roller die configured for molding microstructures onto an optical film, includes an uncoated roller and a number of micro-structures formed on an outer surface of the roller, and a layer of diamond-like carbon film being formed on the surfaces of the micro-structures.

### FIELD

The present disclosure relates to a roller die and a method for manufacturing the roller die.

### BACKGROUND

Optical film, such as prism sheet, is manufactured by steps of providing a substrate; coating UV resin on the substrate; providing a metal roller die with micro-structures on an outer surface of the roller die; pressing the substrate with the UV resin by using the roller die and so transferring the micro-structures onto a surface of the UV resin, a certain of optical film being the result.

### BRIEF DESCRIPTION OF THE DRAWINGS

FIG. 1 is an isometric view of a die to become a roller die in accordance with the first embodiment.

FIG. 2 is a cross-sectional view of the die of FIG. 1

FIG. 3 is a flowchart of a method for manufacturing the roller die of the second embodiment.

FIG. 4 is a sputtering device used in a method of manufacturing the roller die.

### DETAILED DESCRIPTION

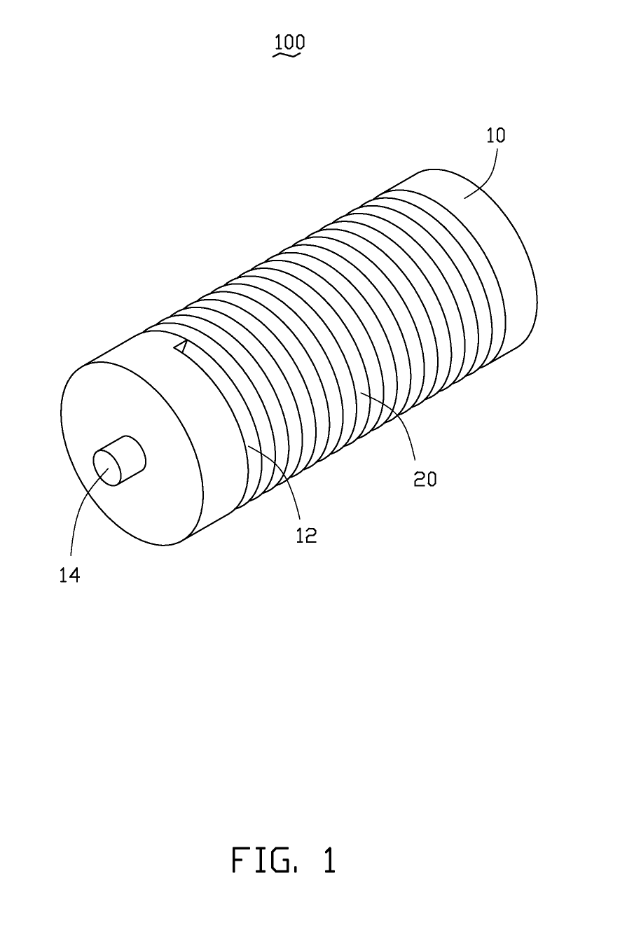

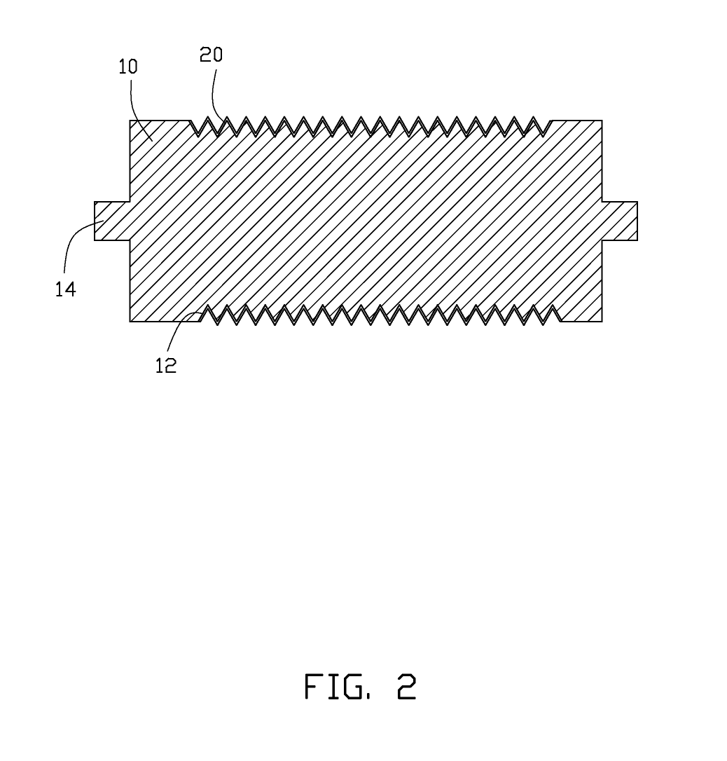

FIGS. 1-2 illustrate a roller die 100 according to the first embodiment. The roller die 100 is configured for molding microstructures on an optical film, and includes a roller 10, a plurality of micro-structures 12 formed on an outer surface of the roller 10, a central axis 14, and a diamond-like carbon film 20 formed on surfaces of the micro-structures 12. The roller 10 is able to rotate around the central axis 14. The microstructure 12 is substantially V-shaped grooves, a depth of a V-groove is about 50 um (microns). A thickness of the diamond-like carbon film 20 is about 200 nm.

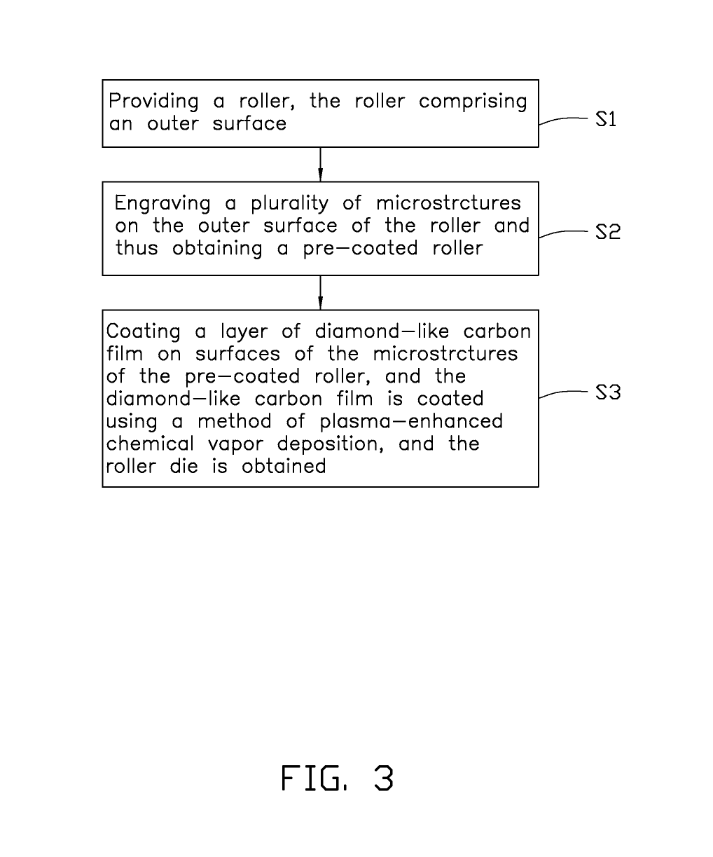

A method for manufacturing the roller die 100, as shown in FIG. 3, comprising steps of:

S1: a roller 10 is provided, the roller 10 is made of metal.

S2: a plurality of microstructures is formed on an outer surface of the roller 10, and a pre-coated roller 30 is obtained, as shown in FIG. 3. The microstructures 12 are formed using laser engraving method or diamond engraving. In the illustrated embodiment, the microstructures 12 are V-shaped grooves, a depth of each V-groove is about 50 um. The microstructure is configured to impart microstructures onto an optical film, and in other embodiments, the micro-structure 31 is not limited to being V-shaped grooves.

S3: a layer of diamond-like carbon film 20 is coated on the surfaces of the micro-structures 12 of the pre-coated roller 30. In the illustrated embodiment, the diamond-like carbon film 20 is applied using a method of plasma-enhanced chemical vapor deposition (PECVD). The plasma enhanced chemical vapor deposition method includes the following steps:

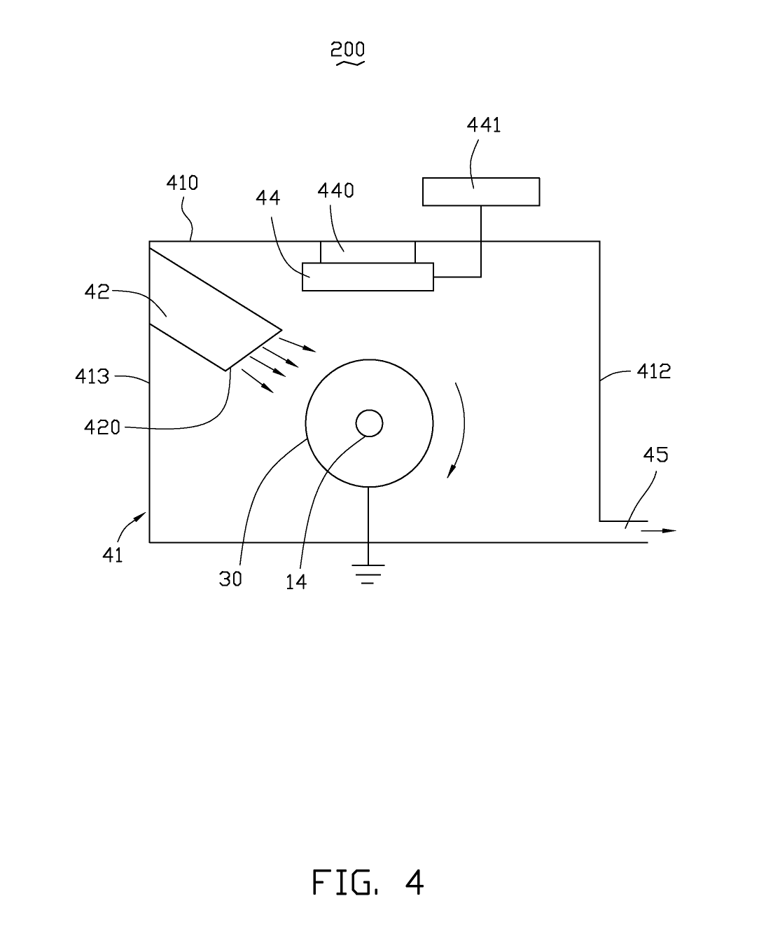

S3.1: a sputtering apparatus 200 is provided, as shown in FIG. 4. The sputtering apparatus 200 includes a reaction chamber 41. The reaction chamber 41 of the sputtering apparatus 200 includes a holder element 440, an electrode 44, and a plate-shaped nozzle 42.

The holder element 440 is arranged on a top wall 410 of the reaction chamber 41, and the electrode 44 is arranged on the holder element 440. The electrode 44 is substantially cubic. The electrode 44 is a metal electrode or a graphite electrode. The electrode 44 is electrically connected to a radio frequency alternating current power source 441 outside the reaction chamber 41. The radio frequency alternating current power source 441 is able to apply AC voltage having a specific frequency, thereby a radio frequency electric field is generated and surrounds the electrode 44. The radio frequency electric field is used to produce plasma ions in a gas in an ionization reaction.

The plate-shaped nozzle 42 is arranged on a second side wall 413 of the reaction chamber 41 and is inclined from the second side wall 413. The plate-shaped nozzle 42 includes an outlet 420, and a reaction gas containing carbon such as acetylene or methane and an inert gas are together introduced in the reaction chamber 41 via the outlet 420. The plate-shaped nozzle 42 is able to increase contact area between plasma ions with the pre-coated roller 30 to improve the uniformity of coating. The inert gas can be a carrier for carrying plasma ions to the surface of the pre-coated roller 30. The inert gas can be selected from a group consisting of argon and nitrogen.

S3.2: the pre-coated roller 30 is arranged in the reaction chamber 41 with an outer surface towards the outlet 420. The pre-coated roller 30 is arranged below the electrode 44, the central axis 14 of the pre-coated roller 30 is parallel with the length of the electrode 44. The pre-coated roller 30 is able to rotate around the central axis 14. The pre-coated roller 30 is connected to ground and maintains an electrical contact with ground, attracting plasma ions for deposition on the outer surface of the pre-coated roller 30.

S3.3: the diamond-like carbon film 20 is coated on the surfaces of the microstructures 12 to obtain a roller die 100. A hardness value of the diamond-like carbon film 20 is about 3000 Hv, and a friction coefficient of the diamond-like carbon film 20 is about 0.01. Specifically, a vacuum in the reaction chamber 41 is maintained at about 10⁻³ torr, and during the coating process, a vent 45 is configured to pump out waste gas to keep the reaction chamber 41 at a low pressure. Both reaction gas and inert gas are introduced into the reaction chamber 41 through the nozzle plate 42, the electrode 44 is powered on to produce a plasma environment, and the pre-coated roller 30 is driven to rotate around its central axis 14. The reaction gas can be stripped of free radicals, metastable molecules, and plasma ions under influence of an electric field, all of which being deposited on the surfaces of the micro-structures 12. The surface micro-structures of the roller die 100 are gradually coated with a layer of diamond-like carbon film 20. A thickness of the diamond-like carbon film 20 is about 200 nm. In a preferred embodiment, before the coating process, the pre-coated roller 30 is heated to a temperature in the range of from about 80 to 150 Celsius degrees.

The diamond-like carbon film 20 on the surfaces of the microstructures 12 avoids oxidation of the metal roller. The diamond-like carbon film 20 has a higher hardness value and a lower friction coefficient compared with an uncoated metal roller, and any scratching of the microstructures 12 is avoided. The phenomenon of adhesive residue on the surfaces of the microstructures is also avoided.

It is to be understood that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A roller die, configured for molding microstructures on an optical film, comprising:
a roller;
a plurality of micro-structures formed on an outer surface of the roller, wherein a layer of diamond-like carbon film is formed on surfaces of the micro-structures.

2. The roller die of claim 1, wherein the microstructures are V-groove shaped.

3. The roller die of claim 1, wherein a depth of the V-groove is about 50 um.

4. The roller die of claim 1, wherein a thickness of the diamond-like carbon film is about 200 nm.

5. The roller die claim 1, wherein the roller die comprises a central axis extending axially outwards from opposite end surface of the roller die.

6. A method for manufacturing a roller die, comprising steps of:
providing a roller, the roller comprising an outer surface;
engraving a plurality of microstructures on the outer surface of the roller and thus obtaining a pre-coated roller;
coating a layer of diamond-like carbon film on surfaces of the microstructures of the pre-coated roller, wherein the diamond-like carbon film is coated using a method of plasma-enhanced chemical vapor deposition.

7. The method for manufacturing a roller die of claim 6, wherein the plasma enhanced chemical vapor deposition method comprises steps of:
providing a sputtering apparatus, the sputtering apparatus comprises a reaction chamber, a plate-shaped nozzle and an electrode, the electrode arranged in the reaction chamber and electrically connected to a radio frequency alternating current power source outside of the reaction chamber, the plate-shaped nozzle configured for ejecting reaction gas and inert gas into the reaction chamber; and
arranging the pre-coated roller in the reaction chamber and an outer surface of the pre-coated roller towards to the plate-shaped nozzle;
driving the pre-coated roller rotate around its central axis;
introducing reaction gas and inert gas into the reaction chamber;
powering on the radio frequency alternating current power source to produce plasma ions in the reacting chamber; the plasma ions depositing on the surfaces of the microstructures, and a layer of diamond-like carbon film is coated on the surfaces of the microstructures.

8. The method for manufacturing a roller die of claim 8, wherein the reaction chamber is substantially cubic, comprises a top wall, a first sidewall and a second sidewall opposite to the first sidewall, the sputtering apparatus comprises a holder element, the holder element is arranged on the top wall and the electrode is arranged on the holder element.

9. The method for manufacturing a roller die of claim 9, wherein the reaction gas is selected from the group consisting of acetylene, methane and combination thereof.

10. The method for manufacturing a roller die of claim 6, the pre-coated roller is heated to a temperature in the range of from about 80 to 150 Celsius degrees before the coating process.

11. The method for manufacturing a roller die of claim 6, wherein a vacuum of the reaction chamber is maintained at about 10⁻³ torr.

12. The method for manufacturing a roller die of claim 6, wherein the sputtering apparatus comprises a vent, the vent is configured for pumping gas away out the reaction chamber to keep the reaction chamber at a low pressure.

13. The method for manufacturing a roller die of claim 6, wherein a thickness of the diamond-like carbon film is about 200 nm.

14. The method for manufacturing a roller die of claim 8, wherein the electrode is electrically connected to a radio frequency alternating current power source outside the reaction chamber.

15. The method for manufacturing a roller die of claim 14, wherein the pre-coated roller is connected to ground and maintains an electrical contact with ground.
